(19) United States
(12) Patent Application Publication
(10) Pub. No.: US 2025/0107554 A1
(43) Pub. Date: Apr. 3, 2025

(54) EDIBLE ANIMAL CHEWS CONTAINING CONCENTRATED FRUIT JUICE, AND METHODS OF MAKING AND USING SUCH EDIBLE ANIMAL CHEWS

(71) Applicant: Société des Produits Nestlé S.A., Vevey (CH)

(72) Inventor: Pierre REYNES, Camon (FR)

(73) Assignee: Société des Produits Nestlé S.A., Vevey (CH)

(21) Appl. No.: 18/828,373

(22) Filed: Sep. 9, 2024

Related U.S. Application Data
(60) Provisional application No. 63/587,499, filed on Oct. 3, 2023.

(51) Int. Cl. A23K 10/30; A23K 20/163; A23K 40/25; A23K 50/40; A61C 17/00

(52) U.S. Cl. CPC A23K 10/30; A23K 20/163; A23K 40/25; A23K 50/40; A61C 17/00

(57) ABSTRACT

An edible pet chew contains a concentrated fruit juice in an amount effective as both a humectant and a plasticizer in the edible pet chew. A method of making an edible pet chew includes extruding a composition containing concentrated fruit juice, the concentrated fruit juice present in the composition in an amount effective as both a humectant and a plasticizer in the composition being extruded. A method of cleaning teeth of a pet includes orally administering an edible chew to the pet, the edible chew containing concentrated fruit juice in an amount effective as both a humectant and a plasticizer in the edible chew. The concentrated fruit juice may replace at least a portion of glycerin and/or propylene in the edible chew, while maintaining or increasing at least one of texture or occupation time for the edible pet chew.

### CROSS REFERENCE TO RELATED APPLICATION

This application claims the benefit of and priority to U.S. Provisional Application Ser. No. 63/587,499 filed Oct. 3, 2023, the disclosure of which is incorporated in its entirety herein by this reference.

### TECHNICAL FIELD

Edible pet chews according to the present disclosure comprise concentrated fruit juice. In some embodiments, the edible pet chew comprises an amount of the concentrated fruit juice effective as both a humectant and a plasticizer in the edible pet chew. Humectants such as glycerin may be at least partially replaced in the edible pet chews by the concentrated fruit juice, which may significantly increase the texture and the occupation time of the edible chew.

### BACKGROUND

Periodontal disease occurs five times more often in pets than in humans. For example, more than 80% of dogs over three years old have periodontal disease. In the wild, many animals eat foods that mechanically abrade plaque and calculus from the teeth. In contrast, pets are usually fed commercially available pet foods that may provide better nutritional value but do not generally subject the teeth to abrasive forces sufficient to clean the teeth. This is even true of dried kibbles, which are able to abrade the teeth only to a very limited extent. In part, this limited abrading is due to the dried kibbles crumbling when chewed by the pet.

Periodontal treatments are painful for dogs and a high cost for dog owners. Therefore, a dog needs dental care to prevent periodontal disease. However, most pet owners are reluctant or unable to provide the routine brushing necessary to maintain good oral health in their pets and would likely welcome an alternative provided by dietary means.

Various products are intended for improving pet dental health. Generally, animal chew toys are made from plastic or other material that cannot be eaten by the animal. Animals typically tire of non-edible animal chew toys after a short period of time and move on to other activities. Moreover, non-edible animal chew toys provide no nutritional value to the animal and are limited in providing a health benefit to the animal. Edible chews have been developed, but they have a complex product design and are sold at a high price as special treats.

Current formulations of edible chews typically contain a source of starch, such as one or both of native starch or pregelatinized starch, extruded with glycerin. Glycerin plays the double role of humectant and plasticizer and has a positive impact on elasticity and resistance of the product, as well as control of water activity. Glycerin is perceived by some consumers as undesirable but is difficult to effectively replace in edible pet chews, due to its significant functionality.

### SUMMARY

The present disclosure relates generally to edible pet chews in which glycerin may be at least partially replaced by concentrated fruit juice, which functions as a natural humectant. This substitution significantly increases the texture of the edible chew and the occupation time of the resultant edible pet chew.

Accordingly, in a general embodiment, the present disclosure provides an edible pet chew comprising concentrated fruit juice. In some embodiments, the edible pet chew comprises an amount of the concentrated fruit juice effective as both a humectant and a plasticizer in the edible pet chew.

In another embodiment, the present disclosure provides a method of making an edible pet chew. The method comprises extruding a composition comprising concentrated fruit juice, preferably an amount of the concentrated fruit juice effective as both a humectant and a plasticizer in the composition, to form the edible pet chew which may optionally be packaged after the extruding.

In yet another embodiment, the present disclosure provides a method of cleaning teeth of a pet. The method comprises administering to the pet any of the edible pet chews disclosed herein and/or an edible pet chew made by any of the methods disclosed herein.

An advantage of the present disclosure is improved edible chews for pets.

Another advantage of the present disclosure is texture improvement of edible chews for pets while increasing occupation time.

Still another advantage of one or more embodiments in the present disclosure is an edible extruded dog chew without any chemical humectants like glycerin or propylene glycol.

Yet another advantage of the present disclosure is edible chews for pet in which the humectant is a natural concentrated fruit juice.

Another advantage of one or more embodiments in the present disclosure is edible chews for pets in which phosphoric acid is at least partially replaced by concentrated lemon juice, which is a natural acid.

Yet another advantage of the present disclosure is replacement of glycerin by a natural concentrated juice from fruits that also improves the mechanical properties of the chew and increases the occupation time in an edible chew for pets.

Still another advantage of the present disclosure is edible chews for pets in which the amount of natural ingredients is at least about 95 wt. %.

Additional features and advantages are described herein, and will be apparent from the following Detailed Description.

### DETAILED DESCRIPTION

As used in this disclosure and the appended claims, the singular forms “a,” “an” and “the” include plural referents unless the context clearly dictates otherwise. Thus, for example, reference to “a chew” includes two or more chews. The term “and/or” used in the context of “X and/or Y” should be interpreted as “X,” or “Y,” or “X and Y.”

All percentages expressed herein are by weight of the total weight of the edible chew unless expressed otherwise. As used herein, “about,” “approximately” and “substantially” are understood to refer to numbers in a range of numerals, for example the range of −10% to +10% of the referenced number, preferably within −5% to +5% of the referenced number, more preferably within −1% to +1% of the referenced number, most preferably within −0.1% to +0.1% of the referenced number. Furthermore, all numerical ranges herein should be understood to include all integers, whole or fractions, within the range. Moreover, these numerical ranges should be construed as providing support for a claim directed to any number or subset of numbers in that range. For example, a disclosure of from 1 to 10 should be construed as supporting a range of from 1 to 8, from 3 to 7, from 1 to 9, from 3.6 to 4.6, from 3.5 to 9.9, and so forth.

The term “pet” means any animal which could benefit from or enjoy the compositions provided by the present disclosure. For example, the pet can be an avian, bovine, canine, equine, feline, hicrine, lupine, murine, ovine, or porcine animal, but the pet can be any suitable animal. The term “companion animal” means a dog or a cat.

The terms “food,” “food product” and “food composition” mean a product or composition that is intended for ingestion by an animal, including a human, and provides at least one nutrient to the animal. The term “pet food” and “pet treat” mean any food composition intended to be consumed by a pet. The term “edible chew” means a comestible product that requires a longer chewing time before the product can be ingested, relative to a standard comestible product. Preferably the edible chew requires at least one minute of chewing before the product can be ingested, for example one to four minutes of chewing before the product can be ingested.

The compositions disclosed herein may lack any element that is not specifically disclosed herein. Thus, a disclosure of an embodiment using the term “comprising” includes a disclosure of embodiments “consisting essentially of” and “consisting of” the components identified. Similarly, the methods disclosed herein may lack any step that is not specifically disclosed herein. Thus, a disclosure of an embodiment using the term “comprising” includes a disclosure of embodiments “consisting essentially of” and “consisting of” the steps identified.

As used herein, “substantially free” means less than 1.00 wt. %, preferably less than 0.10 wt. %, most preferably less than 0.01 wt. % of the total composition.

The terms “enhanced,” “increased,” “improved” and the like mean that an edible chew according to the present disclosure, which at least partially replaces glycerin and/or propylene glycol with concentrated fruit juice, has one or more properties such as texture or occupation time that are at least substantially similar to (and may be greater than) the corresponding properties in a reference edible chew containing the full amount of glycerin and/or propylene glycol.

An aspect of the present disclosure is an edible pet chew comprising concentrated fruit juice. In some embodiments, the edible pet chew comprises an amount of the concentrated fruit juice effective as both a humectant and a plasticizer.

As used herein, a “concentrated fruit juice” is a fruit juice having at least 65% of water removed therefrom, preferably 70% water removed, more preferably 80% water removed. For example, a concentrated fruit juice may have soluble solids from the fruit that is at least about 50 wt. % of the concentrated fruit juice, such as at least about 60 wt. % of the concentrated fruit juice.

In some embodiments, the concentrated fruit juice is selected from the group consisting of: plum, apple, carob, dates, blueberry, strawberry, pear, grape, peach, and mixtures thereof. An exemplary non-limiting embodiment of the concentrated fruit juice comprises a mixture of apple and carob, such as apple juice and carob juice that have been concentrated while in the same composition or separately.

The concentrated fruit juice may be about 5 wt. % to about 25 wt. % of the edible pet chew, preferably about 10 wt. % to about 15 wt. % of the edible pet chew, and most preferably about 12 wt. % of the edible pet chew. The edible chew may be formulated for oral administration to a companion animal such as a dog. In some embodiments, natural ingredients are at least about 95 wt. % of the edible chew. Preferably the water activity (Aw) of the edible pet chew is about 0.65 to about 0.89, more preferably about 0.75 to about 0.85, most preferably about 0.80.

As noted above, an exemplary non-limiting embodiment of the concentrated fruit juice comprises a mixture of apple and carob, such as apple juice and carob juice that have been concentrated while in the same composition or separately. In some embodiments, at least a majority of the solids in the material is derived from at least one of apple or carob; for example, all or substantially all of the solids in the material being derived from at least one of apple or carob.

As used herein, “apple juice” means any material in which at least a portion of the solids in the material is derived from apples (fruit from Malus domestica). In some embodiments, the concentrated apple juice contains one or more of fructose, glucose, sucrose, oligosaccharides, polysaccharides (e.g., starch), malic acid, quinic acid, citromalic acid, tannins (i.e., polyphenols), amides, other nitrogenous compounds, soluble pectin, vitamin C, minerals, ethyl-iso-valerate, methyl-iso-valerate, and any mixture thereof.

As used herein, “carob juice” means any material in which at least a portion of the solids in the material is derived from apples (fruit from Ceratonia siliqua). In some embodiments, the concentrated carob juice contains one or more of sucrose, glucose, fructose, polyphenols (e.g., tannins, flavonoids, phenolic acids), minerals (e.g. K, Ca, Mg, Na, Cu, Fe, Mn, Zn), and any mixture thereof.

In some embodiments, the concentrated fruit juice comprises concentrated plum juice. As used herein, “plum juice” means any material in which at least a portion of the solids in the material is derived from plums (fruit of Prunus domestica L.). In some embodiments, at least a majority of the solids in the material is derived from plums; for example, all or substantially all of the solids in the material being derived from plums. In some embodiments, the concentrated plum juice contains sorbitol and/or xylitol. In some embodiments, the concentrated plum juice contains one or more polyphenolic compounds selected from the group consisting of neochlorogenic acid, 3-O-p-coumaroylquinic acid, chlorogenic acid, 3-feruloylquinic acid, methyl-3-caffeoylquinate, quercetin-3-O-rutinoside, quercetin-3-O-galactoside, quercetin-3-O-glucoside, quercetin-3-O-(6″acetylgalactoside), cyanidin-3-O-glucoside, cyanidin-3-O-rutinoside, peonidin-3-O-rutinoside, and any mixture thereof.

In particularly preferred embodiments, the edible pet chew is substantially free of glycerin and/or substantially free of monopropylene glycol. In a non-limiting exemplary embodiment, the edible pet chew does not comprise any glycerin and does not comprise any monopropylene glycol.

Additionally, some embodiments of the edible pet chew do not comprise any butylene glycol and/or do not comprise any polydextrose. Preferably, the edible pet chew is substantially free of any polyol other than those present in the concentrated fruit juice, e.g., other than sorbitol in concentrated plum juice and/or xylitol in concentrated plum juice. In a non-limiting exemplary embodiment, the only polyol in the edible chew is present in the concentrated fruit juice, e.g., sorbitol in concentrated plum juice and/or xylitol in concentrated plum juice.

In some embodiments, the edible pet chew is a single unitary piece that is substantially homogenous. The edible pet chew may comprise a first end, a second end opposite from the first end, a length defined by the distance between the first end and the second end, and a cross-section having a shape that maintains its dimensions substantially the same along a majority of the length of the edible chew, preferably approximately the entirety of the length of the edible chew, and most preferably the entirety of the length of the edible chew. The length may be about two inches to about ten inches, such as about five inches.

In some embodiments, the edible chew comprises a body having a substantially cylindrical shape and further comprises radial ridges extending from the body substantially parallel to each other along at least a portion of the length of the edible chew, preferably a majority of the length of the edible chew, more preferably approximately the entirety of the length of the edible chew, and most preferably the entirety of the length of the edible chew. However, the edible pet chew can have any shape, and the edible pet chew is not limited to a specific shape.

In some embodiments, the edible chew further comprises a starch or a pre-gelatinized starch, for example one or more of wheat starch, cornstarch, rice starch, tapioca starch, potato starch, pea starch, a pre-gelatinized form of any of these starches, or any mixture thereof. In a non-limiting exemplary embodiment, the edible chew comprises pregelatinized rice starch.

Another aspect of the present disclosure is a method of making an edible pet chew. The method comprises extruding a composition comprising concentrated fruit juice, preferably an amount of the concentrated fruit juice effective as both a humectant and a plasticizer in the composition. The composition is preferably subjected to the extruding in a extruder comprising or associated with a die comprising an opening that imparts a shape to the extrudate to form the edible chew, which optionally may then be packaged after the extruding. The edible chew may be formulated for oral administration to a companion animal such as a dog.

In an exemplary non-limiting embodiment, the extrusion is carried out on an extruder having a specific die design for the dog chew. Dog chews are cut after extrusion, then cooled, and then packed. Concentrated fruit juice is pumped inside the extruder with water and any other liquids. The meal is prepared separately before extrusion with weighing dry ingredients and then mixing and grinding of a blend of the dry ingredients, and then the meal is weighed inside the extruder through a continuing dosing device.

In some embodiments, the composition comprising the concentrated fruit juice and subjected to the extruding further comprises a starch or a pre-gelatinized starch, for example one or more of wheat starch, cornstarch, rice starch, tapioca starch, potato starch, pea starch, a pre-gelatinized form of any of these starches, or any mixture thereof.

Optionally the edible pet chew and/or the composition subjected to the extruding can include other components additional to the concentrated fruit juice and the optional starch, such as one or more of a protein source, a grain, a grain by-product, a vitamin, a mineral, a preservative, an antioxidant, a colorant, a palatant, or a flavorant. In a non-limiting exemplary embodiment, the edible chew comprises concentrated fruit juice, starch (e.g., pregelatinized rice starch), an insoluble fiber (e.g., miscanthus fiber), a soluble fiber, an emulsifier (e.g., monoglyceride), a preservative (e.g., one or both of potassium sorbate or calcium propionate), a flavorant (e.g., wild boar meat), and water (e.g., the remainder of the edible chew being water).

Non-limiting examples of suitable vitamins include vitamin A, any of the B vitamins, vitamin C, vitamin D, vitamin E, and vitamin K, including various salts, esters, or other derivatives of the foregoing. Non-limiting examples of suitable minerals include calcium, phosphorous, potassium, sodium, iron, chloride, boron, copper, zinc, magnesium, manganese, iodine, selenium, and the like. In a particularly preferred embodiment, tricalcium phosphate can be used as a calcium source and as a tartar control agent.

Non-limiting examples of suitable preservatives include potassium sorbate, sorbic acid, sodium methyl para-hydroxybenzoate, calcium propionate, propionic acid, tricalcium phosphate, and combinations thereof. Non-limiting examples of suitable antioxidants include butylated hydroxyanisole (BHA), butylated hydroxytoluene (BHT), vitamin E (tocopherols), and combinations thereof. The antioxidant can provide an aesthetic effect and influence the odor of the edible pet chew, particularly during extended shelf-life.

Non-limiting examples of suitable colorants include FD&C colors, such as blue no. 1, blue no. 2, green no. 3, red no. 3, red no. 40, yellow no. 5, yellow no. 6, and the like; natural colors, such as roasted malt flour, caramel coloring, annatto, chlorophyllin, cochineal, betanin, turmeric, saffron, paprika, lycopene, elderberry juice, pandan, butterfly pea and the like; titanium dioxide; and any suitable food colorant known to the skilled artisan. Non-limiting examples of suitable palatants and flavorants include yeast, tallow, rendered animal meals (e.g., poultry, beef, lamb, and pork), flavor extracts or blends (e.g., grilled beef), animal digests, and the like.

The edible pet chew and/or the composition subjected to the extruding may contain emulsifiers and stabilizers such as soy lecithin, monoglycerides, diglycerides, and the like.

The edible pet chew and/or the composition subjected to the extruding may contain gelatin and/or a gum. Non-limiting examples of suitable gums are gellan gum, xanthan gum, locust bean gum, pectin, carrageenan (e.g., kappa, iota and/or lambda), cellulose gum, gum Arabic and the like, and combinations thereof.

The edible pet chew and/or the composition subjected to the extruding may contain an oil. Non-limiting examples of suitable oils are soybean oil, corn oil, sunflower oil, high oleic sunflower oil, olive oil, canola oil, safflower oil, peanut oil, palm oil, cottonseed oil, coconut oil, almond oil, hazelnut oil, grapeseed oil, and combinations thereof.

The edible pet chew and/or the composition subjected to the extruding may comprise an insoluble fiber, such as one or both of cellulose or miscanthus fiber, and/or a soluble fiber. The edible pet chew and/or the composition subjected to the extruding may comprise concentrated lemon juice, for example in an amount effective to replace at least a portion of any phosphoric acid therein.

Yet another aspect of the present disclosure is a method of reducing or eliminating gycerine and/or propylene glycol in an edible pet chew. A first edible chew formulation comprises a first amount of the glycerin and/or propylene glycol. The method comprises adjusting the first edible chew formulation to a second edible chew formulation. In the second edible chew formulation, at least a portion of the first amount of the glycerin and/or the propylene glycol is replaced with concentrated fruit juice, for example an amount of the concentrated fruit juice approximately equal to the removed amount of the glycerin and/or propylene glycol. The second edible chew formulation has about the same amount of the ingredients other than the glycerin, the propylene glycol, and the concentrated fruit juice, relative to the first edible chew formulation.

The method can be for maintaining or increasing at least one of texture or occupation time (preferably both) for an edible pet chew, by replacing a least a portion of the glycerin and/or propylene glycol with concentrated fruit juice. Preferably the method further comprises producing an edible chew according to the second edible chew formulation. The edible chew may be formulated for oral administration to a companion animal such as a dog.

In some embodiments of this method, phosphoric acid in the first edible chew formulation is at least partially replaced by concentrated lemon juice in the second edible chew formulation.

Yet another aspect of the present disclosure is a method of cleaning teeth of a pet, for example a companion animal such as a dog. The method comprises orally administering to the pet any of the embodiments of the edible chew disclosed herein and/or an edible chew made by any of the embodiments of the method disclosed herein.

### EXAMPLES

By way of example and not limitation, the following examples are illustrative of embodiments of edible chews provided by the present disclosure.

### Example 1

Experimental testing of edible chews formulated as shown in Table 1 unexpectedly achieved enhanced texture as represented by F (N) which was increased by 114% (Table II) and increased occupation time by 43%, 52% and 38% for small, medium and large dogs, respectively (Table III). Furthermore, results which demonstrated that replacing glycerin with a substantially similar amount of plum juice provided a substantially similar geometry of the resultant chew.

TABLE I

| Ingredient | Chew I | Chew II |
|---|---|---|
| Pregelatinized Rice (%) | 72.52 | 72.23 |
| Glycerin | 11.80 | — |
| Concentrated Plum Juice (%) | — | 11.97 |
| Miscanthus Fiber (%) | 2.29 | 2.28 |
| Emulsifier (%) | 0.57 | 0.57 |
| Preservatives (%) | 0.76 | 0.76 |
| Flavor (%) | 0.19 | 0.19 |
| Water (%) | 11.87 | 12.00 |
| Total (%) | 100 | 100 |

For texture, the amount of force in Newton required to penetrate the edible chew was determined by the following procedure: Instron model 5965 texture analyzer was used with the a pyramidal metal probe (probe having 60 major angle and 30 minor angle and 1 mm radius tip) and a base plate with a diameter 10 mm hole. The probe was placed on the Instron shaft and the base plate was placed on the Instron base. The edible chew was placed on the base plate and the probe was lowered to compress the chew with a texture analyzer speed at 1 mm/second. The texture analyzer measurement continued until the force reached 800 Newton or traveled 10 mm from the point of contact.

TABLE II

| | | Chew B (12.0% concentrated |
|---|---|---|
| | Chew A (11.8% glycerin) | plum juice) |
| F(N) | 385.7 | 825.7 |

For occupation time, an edible chew is provided to each of the dogs and then the dog is observed until the edible chew was fully masticated and swallowed.

TABLE III

| | Chew A | Chew B (12.0% |
|---|---|---|
| | (11.8% glycerin) | concentrated plum juice) |
| Occupation time (min) for | 27.5 min | 39.5 min |
| small dogs (50 g chew) | | |
| Occupation time (min) for | 32.4 min | 49.5 min |
| medium dogs (100 g chew) | | |
| Occupation time (min) for | 30.1 min | 41.5 min |
| large dogs (200 g chew) | | |

### Example 2

Experimental testing of edible chews formulated as shown in Table IV unexpectedly achieved the results shown in Table V, which demonstrates that increasing the amount of concentrated plum juice enhanced the texture of the edible chew (measured as noted in the preceding example).

TABLE IV

| Ingredient | Chew I | Chew II |
|---|---|---|
| Pregelatinized Rice (%) | 72.52 | 72.23 |
| Concentrated Plum Juice (%) | 10.31 | 11.97 |
| Miscanthus Fiber (%) | 2.29 | 2.28 |
| Emulsifier (%) | 0.57 | 0.57 |
| Preservatives (%) | 0.76 | 0.76 |
| Flavor (%) | 0.19 | 0.19 |
| Water (%) | 13.36 | 12.00 |
| Total (%) | 100 | 100 |

TABLE V

| | Chew I (10.3% concentrated | Chew II (12.0% concentrated |
|---|---|---|
| | plum juice) | plum juice) |
| F(N) | 726.0 | 825.7 |

### Example 3

Experimental testing of edible chews formulated as shown in Table VI unexpectedly achieved the results shown in Table VII, which demonstrates that concentrated carob and apple juice even further enhanced the texture of the edible chew (measured as noted in the preceding examples; higher force representative of longer occupation time).

TABLE VI

| Ingredient | Chew I | Chew II |
|---|---|---|
| Pregelatinized Rice (%) | 76.82 | 75.06 |
| Concentrated Carob & Apple Juice (%) | 11.30 | 0 |
| Concentrated Plum Juice (%) | 0 | 11.06 |
| Oil (%) | 2.95 | 3.42 |
| Miscanthus Fiber (%) | 2.34 | 2.29 |
| Natural Emulsifier (%) | 1.49 | 1.72 |
| Natural Preservatives (%) | 1.62 | 1.58 |
| Natural Acid (%) | 1.20 | 1.24 |
| Natural Antioxidant (%) | 0.08 | 0.08 |
| Water (%) | 2.20 | 3.55 |
| Total (%) | 100.00 | 100.00 |

TABLE VII

| | | | Force |
|---|---|---|---|
| | Force @ 1 mm (N) | Force @ 5 mm (N) | Max (N) |
| Glycerin | 40 | 254 | 675 |
| Concentrated | 91 | 604 | 1605 |
| Plum Juice | | | |
| Concentrated | 172 | 1166 | 3089 |
| Carob & Apple | | | |
| Juice | | | |

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

1. An edible pet chew comprising concentrated fruit juice in an amount effective as both a humectant and a plasticizer in the edible pet chew.

2. The edible pet chew of claim 1, wherein the edible chew is substantially free of glycerin and substantially free of propylene glycol.

3. The edible pet chew of claim 1 or claim 2, wherein the edible pet chew further comprises a starch.

4. The edible pet chew of any of claims 1-3, wherein the concentrated fruit juice is selected from the group consisting of: plum, apple, carob, dates, blueberry, strawberry, pear, grape, peach, and mixtures thereof.

5. The edible pet chew of any of claims 1-4, wherein the concentrated fruit juice is a mixture of apple and carob.

6. The edible pet chew of any of claims 1-5, wherein the edible pet chew has a property that is at least one of improved texture or increased occupation time, relative to a reference edible pet chew that comprises glycerin and/or propylene glycol instead of the concentrated fruit juice but otherwise identically formulated.

7. A method of making an edible pet chew, the method comprising:
extruding a composition comprising concentrated fruit juice, the concentrated fruit juice present in the composition in an amount effective as both a humectant and a plasticizer in the composition being extruded.

8. The method of claim 7 wherein the extruding is performed in an extruder comprising or associated with a die comprising an opening that imparts a shape to the composition being extruded, to form the edible pet chew.

9. The method of claim 7 or claim 8, wherein the edible pet chew is formulated for oral administration to a dog.

10. The method of any of claims 7-9, wherein the edible chew is substantially free of glycerin and substantially free of propylene glycol.

11. The method of any of claims 7-10, wherein the edible pet chew has a property that is one or both of improved texture or increased occupation time, relative to a reference edible pet chew that comprises glycerin and/or propylene glycol instead of the concentrated fruit juice but otherwise identically formulated.

12. A method of cleaning teeth of a pet, the method comprising orally administering an edible chew to the pet, the edible chew comprising concentrated fruit juice in an amount effective as both a humectant and a plasticizer in the edible chew.

13. The method of claim 12, wherein the edible chew is substantially free of glycerin and substantially free of propylene glycol.

14. The method of claim 12 or claim 13, wherein the edible pet chew has a property that is at least one of improved texture or increased occupation time, relative to a reference edible pet chew that comprises glycerin and/or propylene glycol instead of the concentrated fruit juice but otherwise identically formulated.

15. The method of any of claims 12-14, wherein the pet to whom the edible chew is administered is a dog.
